(19) United States
(12) Patent Application Publication
(10) Pub. No.: US 2005/0289281 A1
(43) Pub. Date: Dec. 29, 2005

(54) Non-blocking switch fabric

(75) Inventor: Jeff Hopkins, Orrington, ME (US)

Correspondence Address: STEUBING AND MCGUINESS & MANARAS LLP, 125 NAGOG PARK, ACTON, MA, 01720, US

(73) Assignee: Tundra Semiconductor Corporation

(21) Appl. No.: 11/146,726

(22) Filed: Jun. 7, 2005

Related U.S. Application Data
(60) Provisional application No. 60/582,351, filed on Jun. 23, 2004.

(51) Int. Cl. G06F 13/00

(52) U.S. Cl. 710/316; 710/310

(57) ABSTRACT

A non-blocking switch fabric with data synchronization of ports coupled thereto includes a switching matrix and a plurality of ports coupled to the switching matrix. Each port has an incoming queue, an outgoing queue, a module for generating a sync packet coupled to the outgoing queue and a module for forwarding or responding to the sync packet coupled to the incoming and outgoing queues in dependence upon destination information carried within a sync packet. In a particular embodiment, the switching fabric is an enhance OCN switching fabric having an 88 bit width.

### RELATED APPLICATIONS

This application claims priority under 35 U.S.C. §1.119(e) to provisional application Ser. No. 60/582,351, filed on Jun. 23, 2004 entitled “Non-Blocking Switch Fabric.”

### FIELD OF THE INVENTION

The present invention relates to non-blocking switch fabrics and is particularly concerned with data synchronization of ports coupled thereto.

### BACKGROUND OF THE INVENTION

All modern electronic devices from cell phones, to DVD players, to high-speed computers, rely extensively on digital data communications to function properly and efficiently. Data communications between multiple Integrated Circuit devices on printed circuit boards, or multiple functional blocks within a single integrated circuit device require these data communications. Traditionally these transfers have been handled through the use of multi-drop busses like, PCI, or multiplexed busses like Advance-Microcontrolled Bus Architecture (AMBA).

In a multi-drop bus, as shown in FIG. 1, all devices are connected to a central set of wires or a bus. When a communication is required, a sending device 14 takes control of the bus and sends its information to the receiving device 16, which is listening to the bus. After the communication is completed the bus is released for the next use by another device.

A multiplexed bus functions in a similar manner to the multi-drop bus with the exception that when a device is granted permission to use the bus it tells a central arbiter with which device it wants to communicate. The arbiter then switches a set of multiplexers to provide a direct circuit between the sender and the receiver. After the communication is completed, the central arbiter is free to connect two other devices. The multiplexed bus provides a higher speed communication capability than the multi-drop bus because there is a direct circuit connection between sender and receiver without the added load of all the other devices sharing the bus.

As the speed and complexity of the electronic devices has increased a need for faster and more efficient data communications has evolved. A major problem with the bus structures described above is that data communication transactions are completed serially or one at a time. A transaction between one sender, to one receiver must wait until all the transactions that are ahead of it in line have completed, even though they may have no relation to the first transaction in question. If a sender of a transaction is ready, but the receiver is not ready, the current transaction can block the completion of subsequent transactions. Both PCI and AMBA have ordering rules, which allow some transactions to pass the current transaction but there is no distinction as to the transaction receiver. If Receiver B is not ready but Receiver C is ready, sender A must still wait to complete the transaction to Receiver B before it attempts the transaction to Receiver C.

Referring to FIG. 2, there is illustrated an example of a known non-blocking switching fabric. Non-blocking switch fabrics help to alleviate this inefficiency. Within a switch fabric, each transaction described above defines a packet. The size of the packets is specific to the fabric in question. A transaction is received at the sender and stored or buffered in the fabric. Some time later, the data is presented at the receiver. During the transmission across the fabric, the data within a packet is stored at various locations within the fabric. Ordering is maintained in the fabric only as it relates to one sender and one receiver. For the example above, when applied to a switch fabric 20, Sender A (14) sends a packet to Receiver B (16), which in turn sends a packet to Receiver C (18). While Receiver B is busy, the packet is stored in the fabric 20. In the meantime, Receiver C is ready to receive its packet and that transaction completes because the packet to Receiver C is not blocked by the A to B transaction.

The non-blocking switch fabric 20 provides a significant performance improvement to the standard multi-drop bus 10. Data flow between different ports is not blocked, and it may also be concurrent when different senders are communicating to different receivers. The problem is with data coherency. In FIG. 2, if Receiver B (16) is receiving multiple packets from multiple senders Receiver B may become backed up while handling multiple transactions. If Sender D (22) sends some data to Receiver B (16) and then sends a message to Sender A (14) that the data is in Receiver B, the packet carrying the data going to Receiver B may become backed up and passed by the packet carrying the message being sent to Sender A. Sender A then requests the new data from Receiver B, but the new data is still in the fabric and has not have made it to Receiver B. Hence, Receiver B responds with the wrong data being unaware that the new data is on its way in the fabric.

Traditional designs have dealt with this problem in either of two ways. First, by implementing an elaborate scheme within the fabric to snoop or look at the destination address of each packet and make sure a read is not executed before a previously posted write. As fabrics become larger and more complex this solution becomes very difficult to implement and manage.

A second, more, often used solution, is to handle the problem in software. This typically requires the original sending port (Sender D in this example) to write a flag location in Receiver B after the required transaction is sent. Sender A then checks this location first to see if the information has arrived at Receiver B before accessing the required information. Unfortunately this solution is also difficult to implement. With the trend toward software reuse, it may be difficult or even impossible to modify the software that is generating the original transactions from sender D.

### SUMMARY OF THE INVENTION

An object of the present invention is to provide an improved a non-blocking switch fabric with data synchronization of ports coupled thereto.

In accordance with an aspect of the present invention there is provided a non-blocking switch fabric with data synchronization of ports coupled thereto comprising a switching matrix, a plurality of ports coupled to the switching matrix, each port having an incoming queue, an outgoing queue, means for generating a sync packet coupled to the outgoing queue and means for forwarding or responding to the sync packet coupled to the incoming and outgoing queues in dependence upon destination information carried within a sync packet.

In accordance with another aspect of the present invention there is provided method of synchronizing data of ports coupled to a non-blocking switch fabric comprising the steps of generating a sync packet at a first port, the sync packet including destination information, receiving the sync packet at a second port and in dependence upon the destination information one of, forwarding the sync packet to a third port and responding to the sync packet.

### BRIEF DESCRIPTION OF THE DRAWINGS

The present invention will be further understood from the following detailed description with reference to the drawings in which:

FIG. 1 illustrates a known multi-drop bus;

FIG. 2 illustrates a known non-blocking switch fabric;

FIG. 3 illustrates in a block diagram non-blocking switch fabric with data synchronization of ports coupled thereto in accordance with an embodiment of the present invention;

FIG. 4 illustrates an enhanced OCN fabric in accordance with an embodiment of the present invention;

FIG. 5 illustrates an enhanced OCN request header in accordance with an embodiment of the present invention;

FIG. 6 illustrates an enhanced OCN response header/data in accordance with an embodiment of the present invention;

FIG. 7 illustrates an enhanced OCN response header with no data in accordance with an embodiment of the present invention;

FIG. 8 illustrates in a block diagram non-blocking switch fabric with data synchronization of ports coupled thereto in accordance with a further embodiment of the present invention; and

FIG. 9 illustrates a sync packet in accordance with an embodiment of the present invention.

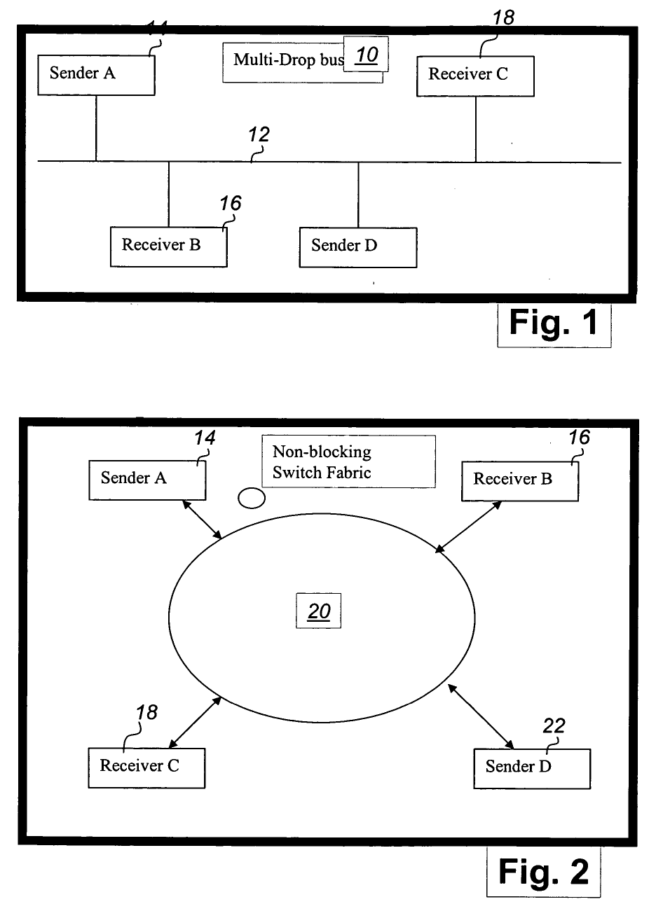

### DETAILED DESCRIPTION OF THE PREFERRED EMBODIMENT

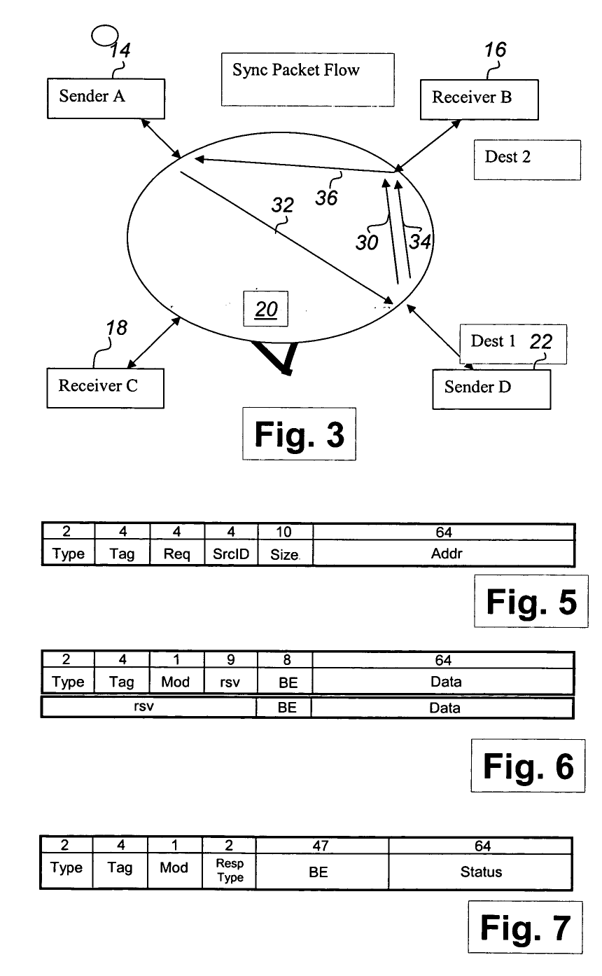

Referring to FIG. 3, there is illustrated in a block diagram non-blocking switch fabrics with data synchronization of ports coupled thereto in accordance with an embodiment of the present invention. The embodiment of FIG. 3 illustrates a special type of transaction called a sync packet. The sync packet acts like a regular read. In the above example, when Sender A (14) receives the “complete” message from Sender D (22), Sender A (14) executes a sync packet either directly. Within the lower address bits, the sync port path 30 (in this case Sender D to Receiver B) is encoded. There is also encoding for a destination 1 (Sender D) 22 and a destination 2 (Receiver B) 16. The Sender D port 22 receives the sync packet 32, sees itself as dest 1, hence forwards 34 the sync packet to the fabric with a destination of Receiver B 16. As ordering is maintained between two similar ports, the sync packet does not arrive at the Receiver B port 16 until after the original write that was sent by Sender D 22. Upon arrival at the Receiver B fabric port 16 the port sees that itself as the dest 2 location and sends 36 a “sync packet complete” response to the originator of the sync packet (sender A (14)). Once that the Sender A receives this response, the Sender A can safely retrieve the information from Receiver B.

Referring to FIG. 4 there is illustrated an enhanced OCN fabric in accordance with an embodiment of the present invention. An embodiment of the present invention is described in further detail in the context the enhanced OCN fabric. The enhanced OCN fabric 40 has a physical layer 42 has a data path widened to 88 bits from 70 bits. The logical layer 44 is 88 bits. The logical layer is PCIX centric: Byte enables are carried with each data phase; and the command field is a PCIX command. The address is a byte address and the count or size is a byte count or byte enables for a single data phase read. Unaligned block transfers are handled with a combination of address and size. A new PCIX specific type of packet has been added to pass PCIX attribute information. This is used only when communicating between PCI blocks.

Referring to FIG. 5 there is illustrated an enhanced OCN request header in accordance with an embodiment of the present invention.

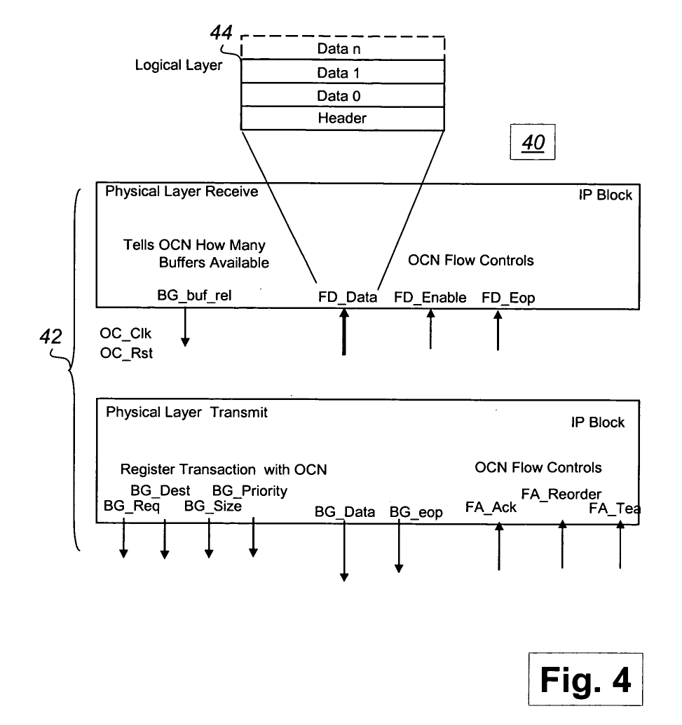

Referring to FIG. 6 there is illustrated an enhanced OCN response header/data in accordance with an embodiment of the present invention.

Referring to FIG. 7 there is illustrated an enhanced OCN response header with no data in accordance with an embodiment of the present invention.

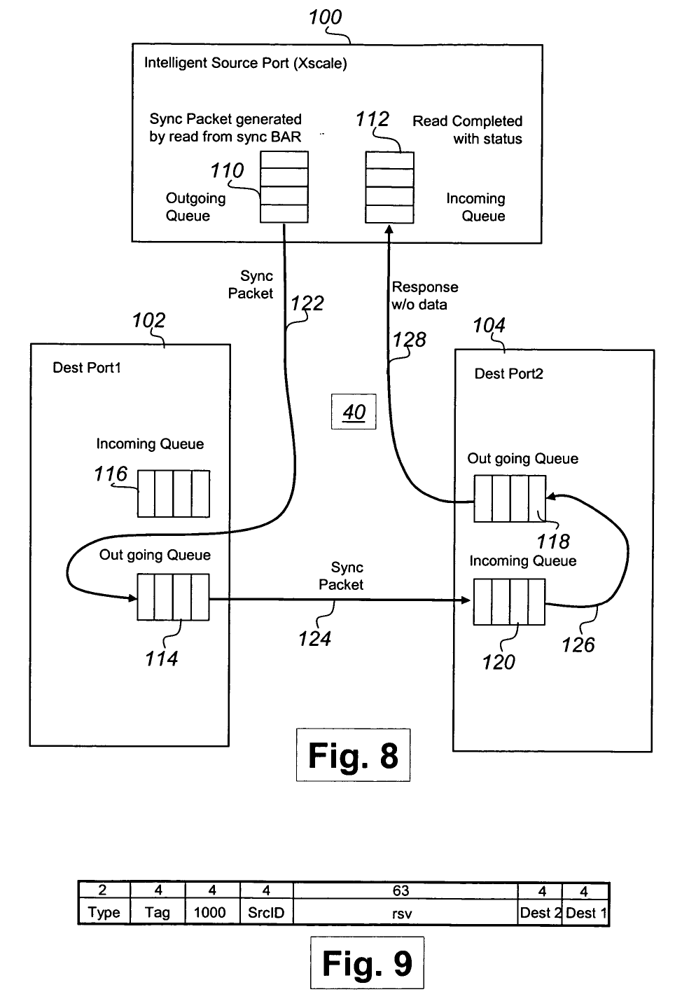

Referring to FIG. 8 there is illustrated in a block diagram non-blocking switch fabric with data synchronization of ports coupled thereto in accordance with a further embodiment of the present invention. FIG. 8 illustrates an embodiment of synch packets implemented on the enhanced OCN fabric of FIG. 4. In FIG. 4, ports 100, 102 and 104 are interconnected via the enhanced OCN switch fabric of FIG. 4. Ports 100, 012 and 104 have outgoing and incoming queues 110 and 112; 114 and 116; and 188 and 120, respectively.

In operation, the port 110 sends a synch packet 122 to destination ports 1 and 2 (pots 102 and 104. The sync packet is passed 124 by destination 1 port 102 to destination 2 port 104. The port 104 generates a response 126, which is sent 128 to the port 100 who originated the sync packet. The port 100 reads the response and knows it is safe to retrieve data from the port 104.

Referring to FIG. 9 there is illustrated a sync packet in accordance with an embodiment of the present invention. FIG. 9 shows the sync packet format for the enhanced OCN fabric of FIG. 4. When in the form of a sync packet a priority of “1” should be carried to flush all posted writes and completions. When converted to a completion at destination port 2 (port 104 in FIG. 8), a priority of “2” should be carried for performance. Incoming PW queues are not blocked as there is a special queue location that holds the sync completion until it is completed. In the case of only one port needing to be flushed, e.g. SDRAM after a DMA interrupt, both Dest 1 and Dest 2 are set to the same port. As the synching port, Dest 2 takes priority, so the receiving port sees that it is destination 2 and sends a response.

Having described an exemplary embodiment of the present invention, it will be appreciated that various modifications may be made without diverging from the spirit and scope of the invention. The above description has talked of the present invention in terms of functional blocks delineated in a manner to facilitate description. However, it should be noted that the invention may be implemented in a variety of arrangements, using hardware, software or a combination thereof, and the present invention is not limited to the disclosed embodiment. It will be understood that each block of any flowchart illustrations, and combinations of blocks in the flowchart illustrations, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

1. A non-blocking switch fabric with data synchronization of ports coupled thereto comprising:
a switching matrix; and
a plurality of ports coupled to the switching matrix;
each port having an incoming queue, an outgoing queue, means for generating a sync packet coupled to the outgoing queue and means for forwarding or responding to the sync packet coupled to the incoming and outgoing queues in dependence upon destination information carried within a sync packet.

2. A non-blocking switch fabric as claimed in claim 1 wherein the switching matrix is an enhanced OCN fabric.

3. A non-blocking switch fabric as claimed in claim 1 wherein the switching matrix has a logical layer that is PCI-X compatible.

4. A method of synchronizing data of ports coupled to a non-blocking switch fabric comprising the steps of:
generating a sync packet at a first port, the sync packet including destination information;
receiving the sync packet at a second port and in dependence upon the destination information one of, forwarding the sync packet to a third port and responding to the sync packet.

5. A method as claimed in claim 4, wherein the switching matrix is an enhanced OCN fabric.

6. A method as claimed in claim 4, wherein the switching matrix has a logical layer that is PCI-X compatible.
